(19) United States
(12) Patent Application Publication
(10) Pub. No.: US 2006/0125721 A1
(43) Pub. Date: Jun. 15, 2006

(54) Plasma display apparatus and apparatus for driving plasma display panel

(75) Inventors: Woong Kee Min, Seoul (KR); Sam Je Cho, Anyang-si (KR)

Correspondence Address: BIRCH STEWART KOLASCH & BIRCH, PO BOX 747, FALLS CHURCH, VA, 22040-0747, US

(73) Assignee: LG Electronics, Inc.

(21) Appl. No.: 11/296,429

(22) Filed: Dec. 8, 2005

(30) Foreign Application Priority Data
Dec. 9, 2004 (KR) 10-2004-0103843

(51) Int. Cl. G09G 3/28

(52) U.S. Cl. 345/60

(57) ABSTRACT

The present invention relates to a plasma display apparatus and an apparatus for driving a plasma display panel. The plasma display apparatus of the present invention comprises a connector into which a terminal of a driving connector is inserted, whereby the terminal of the driving connector and a terminal of the connector are brought in contact with each other and are thus electrically connected to each other. In accordance with the present invention, a driving drive can be replaced when failure occurs in the drive IC, and an additional member such as a TCP frame is not required.

### CROSS-REFERENCES TO RELATED APPLICATIONS

This Nonprovisional application claims priority under 35 U.S.C. §119(a) on Patent Application No. 10-2004-0103843 filed in Korea on Dec. 9, 2004 the entire contents of which are hereby incorporated by reference.

### BACKGROUND OF THE INVENTION

1. Field of the Invention

The document relates to a plasma display apparatus and an apparatus for driving a plasma display panel.

2. Background of the Related Art

A general plasma display panel has excellent characteristics such as self-luminance, high-speed response and a wide viewing angle. There is a tendency that the package type of the data drive IC changes from a Chip On Film (COF) to a Tape Carrier Package (TCP) in order to save the cost and improve the workability of the plasma display panel. The TCP is cheaper than the COF. A supply process and an attachment process of the TCP can be automated.

FIG. 1 is a cross-sectional view of a plasma display apparatus comprising a TCP in which a data drive IC is mounted and a plasma display panel in the related art. FIG. 2 is a lateral cross-sectional view of the plasma display apparatus shown in FIG. 1. As shown in FIGS. 1 and 2, the prior art plasma display apparatus comprises a plasma display panel 1 in which electrodes are formed, a heat dissipation sheet 2, a drive board 3, a TCP support frame 4, a TCP tape 5, a data drive IC 6, a thermal tape 7 and a heat sink 8.

The heat dissipation sheet 2 is attached on a rear surface of the plasma display panel 1. The heat dissipation sheet 2 functions to remove heat generating when the plasma display panel 1 is driven. The drive board 3 is coupled to the TCP support frame 4 and the heat dissipation sheet 2. The drive board 3 outputs a timing control signal that causes the data drive IC 6 to apply an address pulse.

The TCP tape 5 transmits the timing control signal, which is output from the drive board 3, to the data drive IC 6, and transmits the address pulse, which is output from the data drive IC 6, to the address electrode of the plasma display panel 1. The data drive IC 6 is disposed on the TCP support frame 4 and the TCP support frame 4 supports the TCP tape 5.

Meanwhile, the thermal tape 7 is attached to the data drive IC 6 and the heat sink 8 and transfers heat, which is generated from the data drive IC 6, to the heat sink 8. The heat sink 8 dissipates heat, which is received from the thermal tape 7, into the air.

In the related art plasma display apparatus, however, in the case where the address pulse is not transferred from at least one of output terminals of the data drive IC to the address electrode of the plasma display panel, the whole plasma display panel must be replaced. In other words, in the prior art plasma display apparatus, if failure occurs in the data drive IC 6, not only the data driver IC 6, but also the plasma display panel 1 must be replaced because the data drive IC 6 and the plasma display panel 1 cannot be separated from each other.

Furthermore, since the data drive IC 6 is disposed on a flexible TCP tape 5, an additional member, such as the TCP support frame 4, is needed in order to attach the heat sink 8 to the data drive IC 6.

Furthermore, since an additional member such as the TCP support frame 4 is required, there is a need for an additional process of installing an additional member, such as the TCP support frame 4.

### SUMMARY OF THE INVENTION

Accordingly, an object of the embodiment of the present invention is to solve at least the problems and disadvantages of the background art.

It is an object of the embodiment of the present invention to provide a plasma display apparatus and a driving apparatus of a plasma display panel, in which absurdity in which a plasma display panel is replaced when a data drive IC is defective can be obviated.

It is another object of the embodiment of the present invention to provide a plasma display apparatus and a driving apparatus of a plasma display panel, in which an additional member such as a TCP frame is not required.

A plasma display apparatus according to an aspect the present invention comprises a plasma display panel comprising an electrode, a drive board in which a drive IC for outputting a driving pulse to drive the plasma display panel is mounted, a connector comprising a terminal that is electrically connected to an output terminal of the drive IC, and a driving connector connected to the connector and supplying the driving pulse which is output from the output terminal of the drive IC, to the electrode of the plasma display panel.

A plasma display apparatus according to another aspect the present invention comprises a plasma display panel comprising an electrode, a drive board in which a drive IC for outputting a driving pulse to drive the plasma display panel is mounted by means of a film type element, a connector comprising a terminal that is electrically connected to an output terminal of the drive IC, and a driving connector connected to the connector and supplying the driving pulse which is output from the output terminal of the drive IC, to the electrode of the plasma display panel.

A driving apparatus of a plasma display panel for supplying a driving pulse according to an aspect the present invention comprises a drive board in which a drive IC for outputting the driving pulse is mounted, and a connector comprising a terminal that is electrically connected to an output terminal of the drive IC.

The embodiment of the present invention provides a plasma display apparatus in which a terminal of a driving connector is inserted into a connector. This allows a driving board to be replaced when a drive IC is defective. It is thus possible to prevent a plasma display panel from being replaced.

In accordance with the embodiment of the present invention, an additional member is not required since the drive IC is mounted in the driving board.

### BRIEF DESCRIPTION OF THE DRAWINGS

The embodiment of the invention will be described in detail with reference to the following drawings in which like numerals refer to like elements.

FIG. 1 is a cross-sectional view of a plasma display apparatus comprising a TCP in which a data drive IC is mounted and a plasma display panel in the related art;

FIG. 2 is a lateral cross-sectional view of the plasma display apparatus shown in FIG. 1;

FIG. 3 is a plan view of a plasma display apparatus according to a first embodiment of the present invention; and

FIG. 4 is a plan view of a plasma display apparatus according to a second embodiment of the present invention.

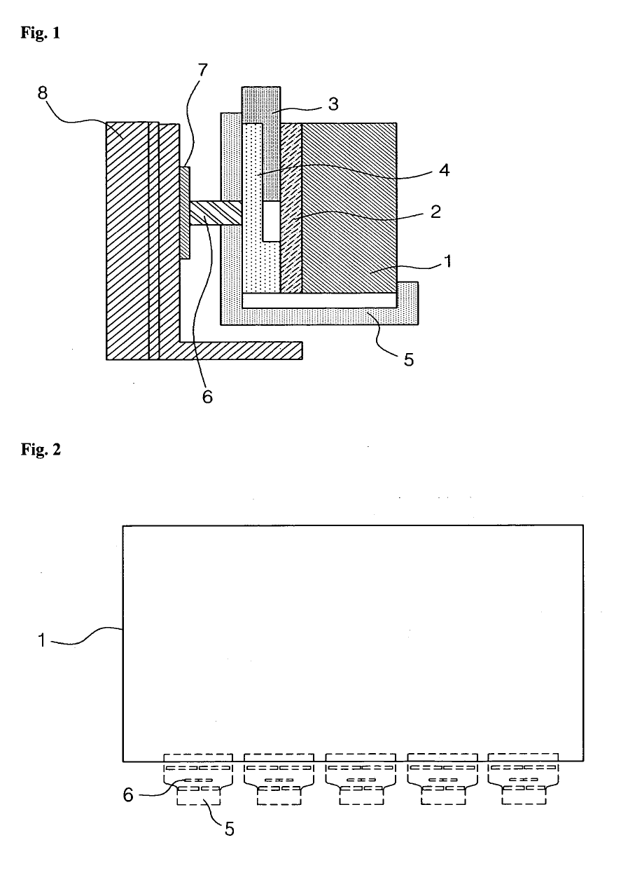

### DETAILED DESCRIPTION OF THE PREFERRED EMBODIMENT

Embodiments of the present invention will be described in a more detailed manner with reference to the drawings.

A plasma display apparatus according to an aspect the present invention comprises a plasma display panel comprising an electrode, a drive board in which a drive IC for outputting a driving pulse to drive the plasma display panel is mounted, a connector comprising a terminal that is electrically connected to an output terminal of the drive IC, and a driving connector connected to the connector and supplying the driving pulse which is output from the output terminal of the drive IC, to the electrode of the plasma display panel.

A terminal of the driving connector may be inserted into the connector, so that the terminal of the driving connector and the terminal of the connector are contacted with each other.

The driving connector may be a Flexible Printed Circuit Board (FPCB) in which a wire electrically connected to the electrode of the plasma display panel is formed.

The drive IC may be a data drive IC and the electrode is an address electrode.

The drive IC may be mounted in the driving board by means of Flip Chip Bonding (FCB).

The driving connector may be electrically connected to the electrode of the plasma display panel by means of an Anisotropic Conductive Film (ACF).

The drive board may be disposed on a rear surface of the plasma display panel.

The drive board may be a hard Printed Circuit Board (PCB).

A plasma display apparatus according to another aspect the present invention comprises a plasma display panel comprising an electrode, a drive board in which a drive IC for outputting a driving pulse to drive the plasma display panel is mounted by means of a film type element, a connector comprising a terminal that is electrically connected to an output terminal of the drive IC, and a driving connector connected to the connector and supplying the driving pulse which is output from the output terminal of the drive IC, to the electrode of the plasma display panel.

The film type element may be either a Chip On Film or a Tape Automated Bonding.

A wire of the film type element and the terminal of the connector may be electrically connected to each other by means of an Anisotropic Conductive Film.

The driving connector may be a Flexible Printed Circuit Board in which a wire electrically connected to the electrode of the plasma display panel is formed.

The drive IC may be a data drive IC and the electrode may be an address electrode.

A terminal of the driving connector may be inserted into the connector, so that the terminal of the driving connector and the terminal of the connector are contacted with each other.

The driving connector may be electrically connected to the electrode of the plasma display panel by means of an Anisotropic Conductive Film.

The drive board may be disposed on a rear surface of the plasma display panel.

The drive board may be a hard Printed Circuit Board.

A driving apparatus of a plasma display panel for supplying a driving pulse according to an aspect the present invention comprises a drive board in which a drive IC for outputting the driving pulse is mounted, and a connector comprising a terminal that is electrically connected to an output terminal of the drive IC.

The drive IC may be mounted in the driving board by means of Flip Chip Bonding.

The drive IC may be mounted in the driving board by means of a film type element.

Embodiments of the present invention will be described in detail with reference to the accompanying drawings.

### Embodiment 1

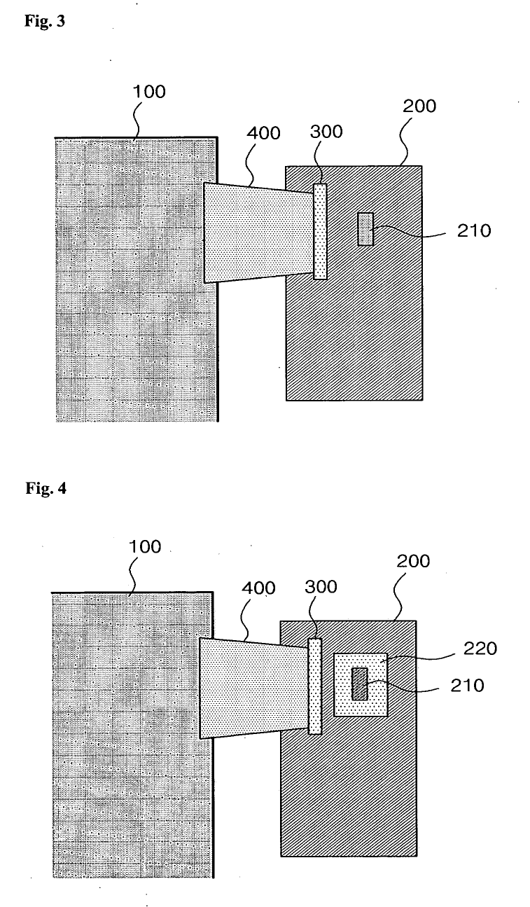

FIG. 3 is a plan view of a plasma display apparatus according to a first embodiment of the present invention. As shown in FIG. 3, the plasma display apparatus according to a first embodiment of the present invention comprises a plasma display panel 100, a drive board 200, a connector 300 and a driving connector 400.

The plasma display panel 100 comprises an upper panel and a lower panel. The upper panel comprises an upper glass substrate, a scan electrode and a sustain electrode formed on the upper glass substrate, an upper dielectric layer that provides insulation between the scan electrode and the sustain electrode, and a protection film that protects the scan electrode and the sustain electrode and facilitates emission of secondary electrons. Furthermore, the lower panel comprises a lower glass substrate, an address electrode formed on the lower glass substrate, for selecting a cell to be emitted, an upper dielectric layer that provides insulation between the address electrodes, barrier ribs that separate the upper panel and the lower panel and form cells, and a phosphor layer coated between the barrier ribs, for radiating light when an inert gas is discharged.

In the drive board 200 is mounted a drive IC 210 for outputting a driving pulse to drive the plasma display panel 100. More particularly, in the case where the drive IC 210 mounted in the drive board 200 is a data drive IC, the data drive IC supplies an address pulse for driving the address electrode of the plasma display panel 100. In a first embodiment of the present invention, the drive IC 210 is mounted in the drive board 200 by means of flip chip bonding. In the flip chip bonding method, a projection, such as a solder ball, is formed in an electrode pattern or an inner lead of the drive IC 210, and the projection is electrically connected to an outer lead of the drive board 200. The drive board 200 includes a hard Printed Circuits Board (PCB). In the case where the drive IC 210 is the data drive IC, the data drive IC consists of approximately 64 or 96 FETs (Field Effect Transistor) that are interconnected.

The connector 300 comprises a terminal that is electrically connected to an output terminal of the drive IC 210. In a first embodiment of the present invention, the output terminal of the drive IC 210, i.e., the inner lead of the drive IC 210 is connected to the outer lead of the drive board 200, and the outer lead of the drive board 200 is connected to the terminal of the connector 300. As a result, the terminal of the connector 300 and the output terminal of the drive IC 210 are electrically connected to each other.

The drive board 200 and the connector 300 constitute the driving apparatus of the plasma display panel.

The driving connector 400 is connected to the connector 300 and supplies the driving pulse, which is output from the output terminal of the drive IC 210, to the electrodes of the plasma display panel 100. That is, if the terminal of the driving connector 400 is inserted into the connector 300, the terminal of the driving connector 400 and the terminal of the connector 300 are brought in contact with each other and are then electrically connected to each other. In the case where the drive IC 210 is a data drive IC, the driving connector 400 supplies the address pulse, which is output from the data drive IC, to the address electrode of the plasma display panel 100.

The driving connector 400 is a Flexible Printed Circuit Board(FPCB) in which wires electrically connected to the electrodes of the plasma display panel 100 are formed. The driving connector 400 such as the FPCB is electrically connected to the electrodes of the plasma display panel 100 by means of an Anisotropic Conductive Film (ACF). In the ACF, conductive particles, such as plastic or metal particles that are coated with metal, are dispersed in the ACF. If the ACF is coated on the electrodes of the plasma display panel 100 and the wires of the FPCB and the electrodes of the plasma display panel 100 are aligned, pressure is applied to the FPCB. Therefore, the conductive particles of the ACF between the wires of the FPCB and the electrodes of the plasma display panel 100 are brought in contact with each other and thus have conductivity. The conductive particles of the ACF in the remaining regions are separated from each other and thus have an insulation property.

In FIG. 3, it has been shown that the drive board 200 and the plasma display panel 100 are located on the same plane. In reality, however, the drive board 200 is placed on a rear surface of the plasma display panel 100.

In the first embodiment of the present invention, as the terminal of the driving connector 400 is inserted into the connector 300, the driving pulse is supplied to the address electrode of the plasma display panel. In the case where failure occurs in the drive IC 210, the driving connector 400 is separated from the connector 300, and the connector 300 of the driving board 200 in which a normal drive IC 210 is mounted and the driving connector 400 are connected to each other. Therefore, the plasma display panel 100 can operate normally. As described above, the driving board is replaced when failure occurs in the drive IC 210. It is thus possible to prevent the plasma display panel from being replaced as in the related art.

Furthermore, in the related art plasma display apparatus, an additional member, such as a TCP frame, is required because the drive IC is disposed on the TCP tape. In the plasma display apparatus according to the first embodiment of the present invention, however, there is no need for an additional member because the drive IC 210 is mounted in the driving board 200.

### Embodiment 2

FIG. 4 is a plan view of a plasma display apparatus according to a second embodiment of the present invention. As shown in FIG. 4, the plasma display apparatus according to a second embodiment of the present invention comprises a plasma display panel 100, a drive board 200, a connector 300 and a driving connector 400. The plasma display panel 100 and the driving connector 400 according to the second embodiment of the present invention are the same as those according to the first embodiment of the present invention. Therefore, detailed description thereof will be omitted.

The drive board 200 according to the second embodiment of the present invention has a drive IC 210 that outputs a driving pulse for driving the plasma display panel 100 mounted therein. More particularly, in the case where the drive IC 210 mounted in the drive board 200 is a data drive IC, the data drive IC supplies an address pulse for driving the address electrode of the plasma display panel 100. In a second embodiment of the present invention, the drive IC 210 is mounted in the drive board 200 by means of a film type element 220 such as COF or Tape Automated Bonding (TAB). The COF or TAB is a film type element in which the terminal and wire of the drive IC are connected on a tape film and are sealed with resin. The drive board 200 consists of a hard PCB.

The connector 300 comprises a terminal that is electrically connected to an output terminal of the drive IC 210. In the second embodiment of the present invention, the wire of the film type element 220, which corresponds to the output terminal of the drive IC 210, and the terminal of the connector 300 are connected to each other by means of an ACF. Therefore, the terminal of the connector 300 and the output terminal of the drive IC 210 are electrically connected to each other.

The drive board 200 and the connector 300 constitute the driving apparatus of the plasma display panel.

In the second embodiment of the present invention, as the terminal of the driving connector 400 is inserted into the connector 300, the driving board can be replaced when failure occurs in the drive IC 210. It is thus possible to prevent the plasma display panel from being replaced as in the related art.

Furthermore, in the related art plasma display apparatus, an additional member, such as a TCP frame, is required because the drive IC is disposed on the TCP tape. In the plasma display apparatus according to the second embodiment of the present invention, however, there is no need for an additional member because the drive IC 210 is mounted in the driving board 200.

The invention being thus described, it will be obvious that the same may be varied in many ways, Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising an electrode;
a drive board in which a drive IC for outputting a driving pulse to drive the plasma display panel is mounted;
a connector comprising a terminal that is electrically connected to an output terminal of the drive IC; and
a driving connector connected to the connector and supplying the driving pulse which is output from the output terminal of the drive IC, to the electrode of the plasma display panel.

2. The plasma display apparatus as claimed in claim 1, wherein a terminal of the driving connector is inserted into the connector, so that the terminal of the driving connector and the terminal of the connector are contacted with each other.

3. The plasma display apparatus as claimed in claim 1, wherein the driving connector is a flexible printed circuit Board in which a wire electrically connected to the electrode of the plasma display panel is formed.

4. The plasma display apparatus as claimed in claim 1, wherein the drive IC is a data drive IC and the electrode is an address electrode.

5. The plasma display apparatus as claimed in claim 1, wherein the drive IC is mounted in the driving board by means of Flip Chip Bonding.

6. The plasma display apparatus as claimed in claim 1, wherein the driving connector is electrically connected to the electrode of the plasma display panel by means of an Anisotropic Conductive Film.

7. The plasma display apparatus as claimed in claim 1, wherein the drive board is disposed on a rear surface of the plasma display panel.

8. The plasma display apparatus as claimed in claim 1, wherein the drive board is a hard Printed Circuit Board.

9. A plasma display apparatus comprising:
a plasma display panel comprising an electrode;
a drive board in which a drive IC for outputting a driving pulse to drive the plasma display panel is mounted by means of a film type element;
a connector comprising a terminal that is electrically connected to an output terminal of the drive IC; and
a driving connector connected to the connector and supplying the driving pulse which is output from the output terminal of the drive IC, to the electrode of the plasma display panel.

10. The plasma display apparatus as claimed in claim 9, wherein the film type element is either a Chip On Film or a Tape Automated Bonding.

11. The plasma display apparatus as claimed in claim 9, wherein a wire of the film type element and the terminal of the connector are electrically connected to each other by means of an Anisotropic Conductive Film.

12. The plasma display apparatus as claimed in claim 9, wherein the driving connector is a Flexible Printed Circuit Board in which a wire electrically connected to the electrode of the plasma display panel is formed.

13. The plasma display apparatus as claimed in claim 9, wherein the drive IC is a data drive IC and the electrode is an address electrode.

14. The plasma display apparatus as claimed in claim 9, wherein a terminal of the driving connector is inserted into the connector, so that the terminal of the driving connector and the terminal of the connector are contacted with each other.

15. The plasma display apparatus as claimed in claim 9, wherein the driving connector is electrically connected to the electrode of the plasma display panel by means of an Anisotropic Conductive Film.

16. The plasma display apparatus as claimed in claim 9, wherein the drive board is disposed on a rear surface of the plasma display panel.

17. The plasma display apparatus as claimed in claim 9, wherein the drive board is a hard Printed Circuit Board.

18. An apparatus for driving a plasma display panel for supplying a driving pulse, comprising:
a drive board in which a drive IC for outputting the driving pulse is mounted; and
a connector comprising a terminal that is electrically connected to an output terminal of the drive IC.

19. The apparatus as claimed in claim 18, wherein the drive IC is mounted in the driving board by means of Flip Chip Bonding.

20. The apparatus as claimed in claim 18, wherein the drive IC is mounted in the driving board by means of a film type element.
